(19) United States
(12) Patent Application Publication
(10) Pub. No.: US 2015/0194003 A1
(43) Pub. Date: Jul. 9, 2015

(54) ERRONEOUS COIN INSERTION PREVENTIVE MECHANISM OF BANKNOTE HANDLING MACHINE

(71) Applicant: FUJITSU FRONTECH LIMITED, Tokyo (JP)

(72) Inventors: Hiroshi Yanagida, Inagi (JP); Koichi Hosoyama, Inagi (JP); Ryosuke Ebinuma, Inagi (JP); Shohei Koizumi, Inagi (JP); Tatsuya Shimamura, Inagi (JP)

(21) Appl. No.: 14/666,586

(22) Filed: Mar. 24, 2015

Related U.S. Application Data
(63) Continuation of application No. PCT/JP2012/080762, filed on Nov. 28, 2012.

(51) Int. Cl. G07D 11/00

(52) U.S. Cl. CPC G07D 11/0018

(57) ABSTRACT

An erroneous coin insertion preventive mechanism of a banknote handling machine prevents a user from erroneously inserting a coin (or a token) through a banknote slot of the banknote handling machine. When a coin 28 is erroneously inserted through a banknote slot 17, an erroneous coin insertion preventive mechanism 20 holds the rigid coin 28 by three points of a front end contact part 29 and a rear lower surface contact part 31 formed by a horizontal surface 26 and a conveyance path lower surface part 27, and an upper surface intermediate contact part 32 formed by a lower bent part of a descending slope surface of a conveyance path upper surface part 24, thereby preventing the coin 28 from entering an inside of the device from the banknote slot 17. A gap L is provided between the conveyance path upper surface part 24 and the conveyance path lower surface part 27 so that a banknote bundle 33 of a specified number of flexible banknotes thicker than the coin 28 may pass through the gap in bent form.

### CROSS-REFERENCE TO RELATED APPLICATION

This application is continuation application of International Application PCT/JP2012/080762 filed on Nov. 28, 2012 and designated the U.S., the entire contents of which are incorporated herein by reference.

### FIELD OF THE INVENTION

The present invention is related to an erroneous coin insertion preventive mechanism of a banknote handling machine, and more specifically to an erroneous coin insertion preventive mechanism of a banknote handling machine which prevents a user from erroneously inserting a coin (or a token) into the banknote inlet of the banknote handling machine.

### BACKGROUND OF THE INVENTION

Conventionally proposed as a banknote handling device which collectively handles a bundle of banknotes is a banknote handling device which prevents erroneous drawal by confirming the type of banknotes in the bundle according to the image pattern detected on the surface of the bundle of the banknotes supplied at the drawal although erroneous insertion of a bundle of banknotes occurs in a storage unit. (For example, refer to Japanese Laid-open Patent Publication No. 2001-067511.)

Also proposed as a banknote teller machine and a cash dispenser which handles a bundle of banknotes is a device which stores banknotes of different sized by arranging them in order, regulates the proceeding position of the banknotes supplied to the integrated space in which banknotes are piled and stored, and controls the regulation position based on the dimensions of the banknotes taken into a feeding device. (For example, refer to Japanese Laid-open Patent Publication No. 2006-163917.)

FIG. 1A is a perspective view of a common appearance in the above-mentioned banknote bundle handling device and banknote bundle teller device. FIG. 1B illustrates the case where a banknote handling machine of the mechanism which internally feeds banknotes sheet by sheet with a part of the banknotes left outside the device. FIG. 1C illustrates the case where a banknote handling machine first takes a bundle of banknotes in the device, and then starts feeding each sheet internally.

In FIG. 1A described above, a mounting 2 is formed to place a bundle of banknotes on a banknote bundle handling device 1, and a slot 3 through which the bundle of banknotes is to be inserted is formed beyond the mounting 2. The bundle of banknotes, which is not illustrated in FIG. 2 is placed on the mounting 2 by a user, and then pushed into the slot 3 as indicated by an arrow a.

In a banknote bundle handling device 1a in the system illustrated in FIG. 1B, a banknote bundle 4 is fed into the device sheet by sheet by a feed roller 5 with the rear end portion of the banknote bundle 4 kept on the mounting 2, and conveyed to the internal conveyance path by a conveyance roller pair 6.

In a banknote bundle handling device 1b in the system illustrated in FIG. 1C, the banknote bundle 4 (indicated by broken lines) placed on the mounting 2 and pushed into the slot 3 is taken in the inside of the device by a conveyance roller pair 7 (indicated by solid lines), fed sheet by sheet into the inside of the device by a feed roller 8 as indicated by an arrow c, and conveyed to the internal conveyance path by another conveyance roller pair 9.

However, a user of a banknote bundle handling device may erroneously insert a coin (or a token) into the slot 3. As a countermeasure, the coin may be received on a tray inside of the device, taken out of the tray after stopping the device according to the information from the user, and then returned to the user.

FIG. 2A briefly illustrates a mechanism of receiving an erroneously inserted coin on the tray. FIG. 2B illustrates a mechanism in which the vertical gap of a slot is made smaller than the thickness of a coin to prevent the coin from entering through the slot. In FIGS. 2A and 2B, the components having the same configurations or functions as those in FIGS. 1A, 1B, and 1C are assigned the same reference numerals.

In the case in FIG. 2A, a coin 10 erroneously inserted into the slot 3 of the banknote bundle handling device is designed to drop and stay on a tray 11 provided in the downstream of the conveyance roller pair 7. In the case in FIG. 2B, the vertical gap f of the insertion path beyond the slot 3 is smaller than the thickness e of the coin 10.

### BRIEF SUMMARY OF THE INVENTION

An erroneous coin insertion preventive mechanism of a banknote handling machine according to the first invention collectively feeds a bundle of banknotes, which are placed on a mounting and inserted through a banknote slot, from the banknote slot to the inside of a device. The mechanism includes: a conveyance path upper surface which forms a vertical surface and a descending slope surface from the vertical surface in the direction of the inside of the device at the banknote slot, and forms a horizontal surface in the direction of the inside of the device successively to the descending slope surface; and a conveyance path lower surface which forms a descending slope surface facing the descending slope surface of the descending slope surface of the conveyance path upper surface successively to the horizontal surface of the mounting at the banknote slot, and a horizontal surface facing the horizontal surface of the conveyance path upper surface successively to the descending slope surface. With the configuration, the horizontal surface of the conveyance path lower surface forms a front end contact part which contacts an insertion direction front end part of a coin when the coin is erroneously inserted through the banknote slot, a bent part which changes from the horizontal surface of the mounting of the conveyance path lower surface to the descending slope surface forms a rear lower surface contact part which contacts the lower surface of a rear part in the insertion direction from the center of the coin when the coin is erroneously inserted through the banknote slot, a bent part which changes from the descending slope surface of the conveyance path upper surface to the horizontal surface forms an upper surface intermediate contact part which contacts the upper surface part of the coin at the intermediate position between the front end which contacts the front end contact surface of the coin when the coin is erroneously inserted through the banknote slot and a rear lower surface part which contacts the rear lower surface contact part, and three points of the front end contact part, the rear lower surface contact part, and the upper surface intermediate contact part support the coin when the coin is erroneously inserted through the banknote slot, and the three points prevent the coin from entering the inside of the device through the banknote slot.

An erroneous coin insertion preventive mechanism of a banknote handling machine according to the second invention collectively feeds a bundle of banknotes, which are placed on a mounting and inserted through a banknote slot, from the banknote slot to the inside of a device. The mechanism includes: a conveyance path upper surface which forms a vertical surface and a descending slope surface from the vertical surface in the direction of the inside of the device at the banknote slot, forms an inlet horizontal surface successively to the descending slope surface in the direction of the inside of the device, forms an ascending slope surface successively to the inlet horizontal surface in the direction of the inside of the device, and forms an internal horizontal surface successively to the ascending slope surface in the direction of the inside of the device; and a conveyance path lower surface which forms an inlet horizontal surface extending in the direction of the inside of the device from the position of the ascending slope surface of the conveyance path upper surface and an ascending slope surface successively to the inlet horizontal surface in the direction of the inside of the device, and forms an internal horizontal surface successively to the ascending slope surface in the direction of the inside of the device. With the configuration, when the coin is erroneously inserted through the banknote slot, the inlet horizontal surface of the conveyance path upper surface contacts an upper surface intermediate part of the coin whose front end is being lifted in contact with the ascending slope surface of the conveyance path lower surface, and squeezes the upper surface intermediate part of the coin, and the ascending slope surface of the conveyance path lower surface and the inlet horizontal surface of the conveyance path upper surface squeeze the coin, thereby preventing the coin from entering the inside of the device through the banknote slot.

An erroneous coin insertion preventive mechanism of a banknote handling machine according to the third invention collectively feeds a bundle of banknotes, which are placed on a mounting and inserted through a banknote slot, from the banknote slot to the inside of a device. The mechanism includes: an upper conveyance path surface formed by alternately and successively providing a convex part and a concave part in the horizontal slot direction orthogonal to the banknote bundle insertion direction at the banknote slot; and a lower conveyance path surface formed by alternately and successively providing a convex part and a concave part in the horizontal slot direction orthogonal to the banknote bundle insertion direction at the banknote slot. With the configuration, the convex part and the concave part of the lower conveyance path surface respectively face the concave part and the convex part of the upper conveyance path surface, the convex part and the concave part of the upper conveyance path surface and the convex part and the concave part of the lower conveyance path surface are formed as having a width smaller than the diameter of the coin which is erroneously inserted through the banknote slot, the vertical distance between the convex part and the concave part of the lower conveyance path surface and the facing concave part and the convex part of the upper conveyance path surface is the distance which allows the bundle of banknotes to be inserted to pass through the banknote slot.

### BRIEF DESCRIPTION OF THE SEVERAL VIEWS OF THE DRAWING

FIG. 1A is a perspective view of the common appearance of a conventional banknote bundle handling device or a banknote bundle teller machine, FIG. 1B illustrates a banknote handling machine of a mechanism of internally feeding banknotes sheet by sheet with a part of the banknotes left outside the device, and FIG. 1C illustrates a banknote handling machine which starts feeding a bundle of banknotes sheet by sheet to the inside of the machine after taking the banknotes in the machine;

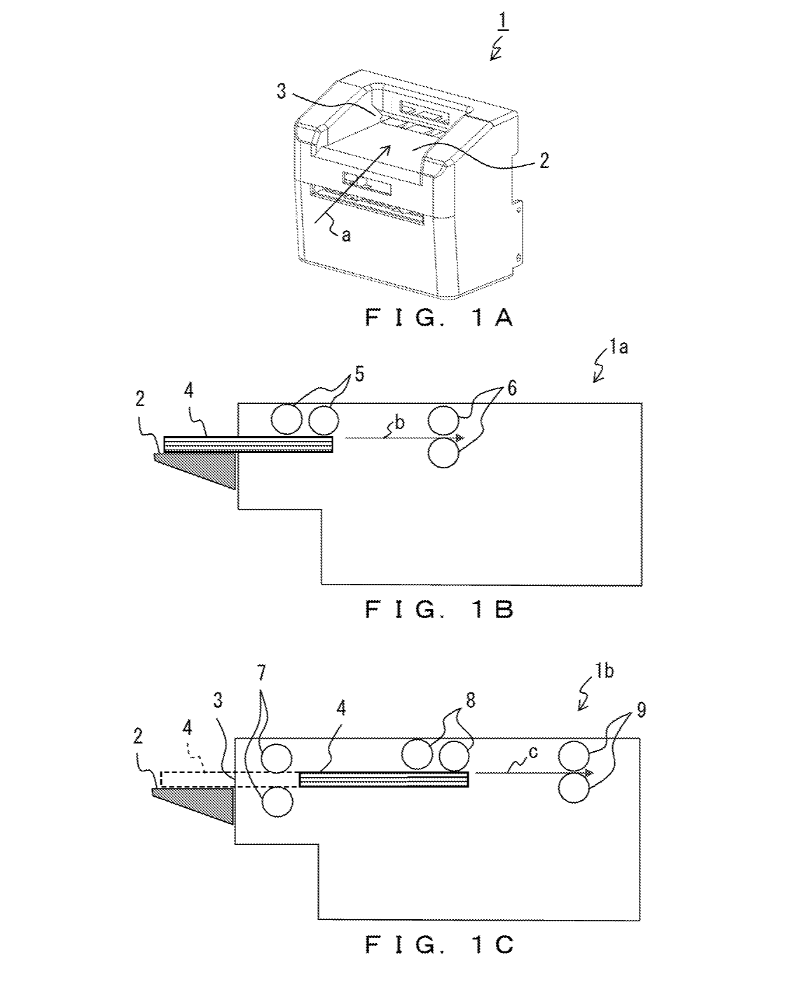

FIG. 2A briefly illustrates the mechanism of receiving an erroneously inserted coin on the tray in a conventional banknote bundle handling device and a banknote bundle teller device, and FIG. 2B illustrates the conventional mechanism in which the vertical gap of the slot is smaller than the thickness of a coin so that the coin is not to enter the slot;

FIG. 3 is a side sectional view of the configuration of only the upper part of the erroneous coin insertion preventive mechanism of a banknote handling machine having the erroneous coin insertion preventive mechanism according to the embodiments 1 through 3 of the present invention;

FIGS. 4A, 4B, and 4C illustrate the configuration and the function of the erroneous coin insertion preventive mechanism according to the embodiment 1 of the present invention;

FIG. 5 illustrates the positional relationship among three points of the front end contact part, the rear lower surface contact part, and the upper surface intermediate contact part of the erroneous coin insertion preventive mechanism according to the embodiment 1 of the present invention;

FIGS. 6A, 6B, and 6C illustrate the concrete aspects of preventing a coin from entering a banknote slot of the erroneous coin insertion preventive mechanism according to the embodiment 1 of the present invention;

FIG. 7 illustrates the configuration and the function of the erroneous coin insertion preventive mechanism according to the embodiment 2 of the present invention; and

FIG. 8 illustrates the configuration and the function of the erroneous coin insertion preventive mechanism according to the embodiment 3 of the present invention.

### DETAILED DESCRIPTION OF THE INVENTION

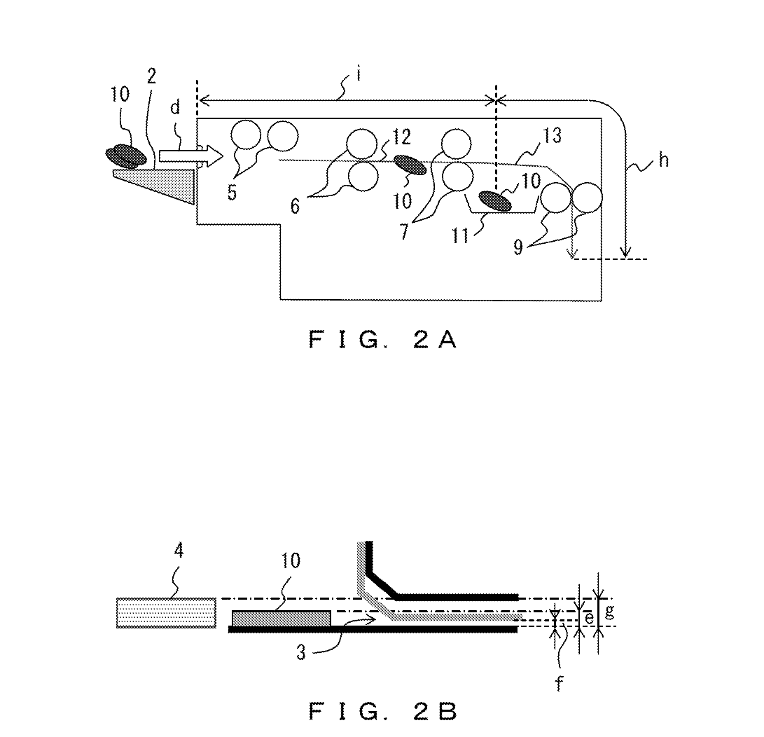

In the case illustrated in FIG. 2A, although there occurs no fault in a downstream conveyance path 13 (in the range indicated by an arrow h) from the tray 11 after the coin 10 drops on the tray 11, the coin 10 which enters through the slot 3 may be caught or stuck in an upstream conveyance path 12 from the tray 11 (in the range indicated by an arrow i) before the coin 10 drops on the tray 11, thereby possibly causing a jam or other faults.

That is, since a valuable object such as the coin 10 etc. is taken in the body of the device, trouble of money may be caused. Furthermore, it is inconvenient that the coin 10 taken in the device is not to be taken out without stopping the body of the device.

In addition, in the case illustrated in FIG. 2B, when the vertical gap of the slot 3 is made smaller to prevent a coin from being erroneously inserted, it is inconvenient that even a bundle of about 20 banknotes having the thickness of g is not to be collectively inserted.

The embodiments of the present invention are described below in detail with reference to the attached drawings.

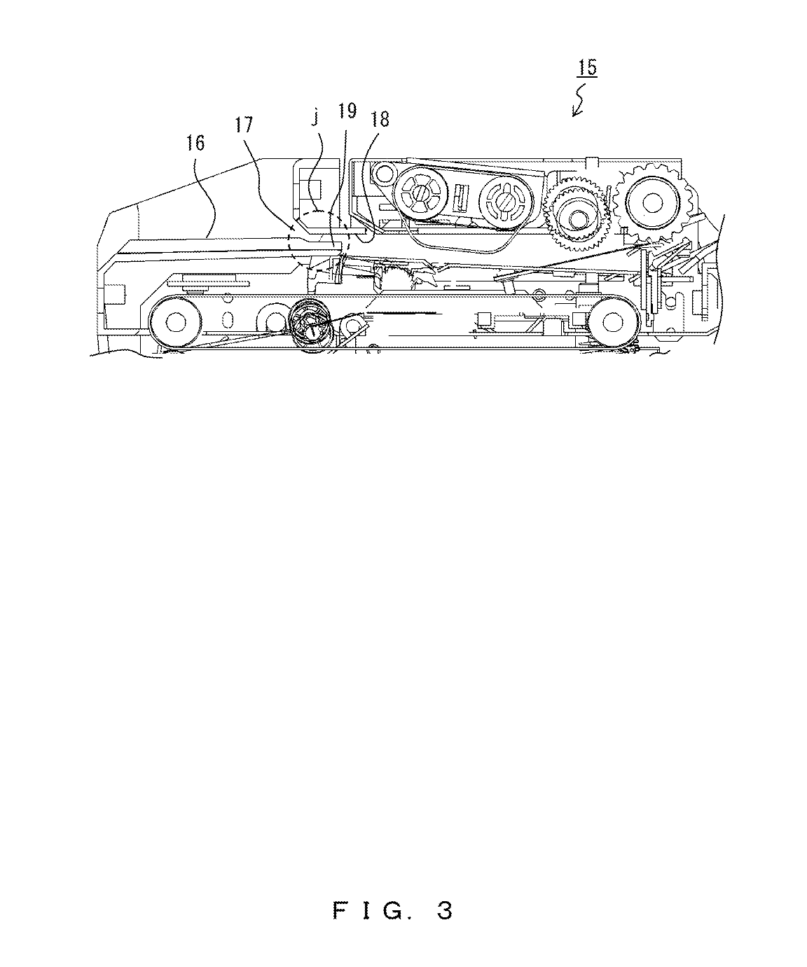

FIG. 3 is a side sectional view of the configuration of only the upper part of the erroneous coin insertion preventive mechanism of a banknote handling machine having the erroneous coin insertion preventive mechanism according to the embodiments 1 through 3 of the present invention. A banknote handling machine 15 includes a mounting 16 provided with a horizontal surface on which a user places a bundle of banknotes at the upper front part of the body of a device, and a banknote slot 17 is formed at the position where the mounting 16 extends in the direction of the inside of the body of the device.

From the banknote slot 17, formed are an upper conveyance surface 18 and a lower conveyance surface 19 which extend in the direction of the inside the body of the device, and. In FIG. 3, the part enclosed by a dashed circle j is a part which configures the erroneous coin insertion preventive mechanism according to the present invention. The explanation of other components is omitted because they are components of a common banknote handling machine.

### Embodiment 1

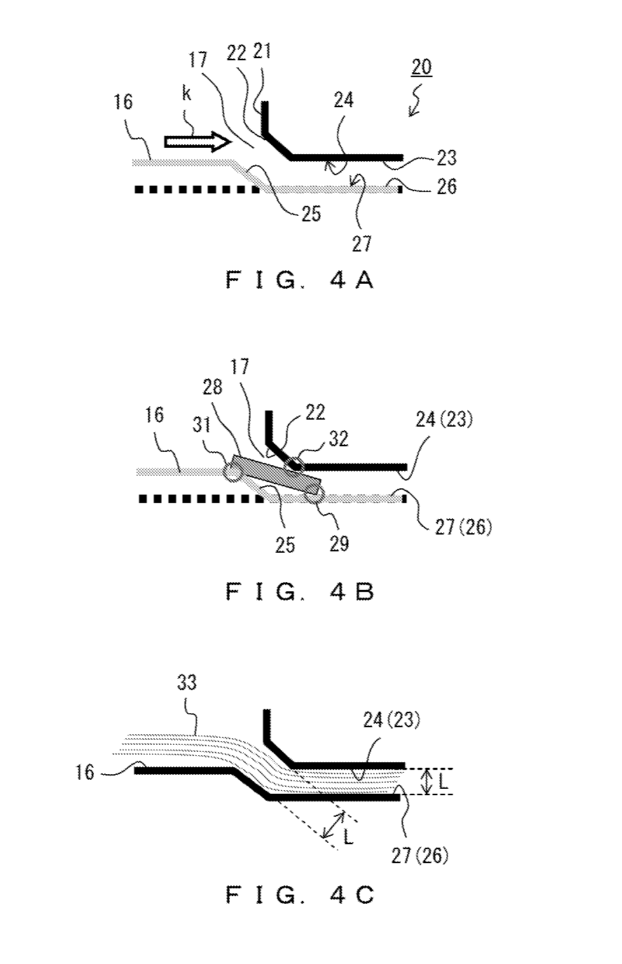

FIGS. 4A, 4B, and 4C illustrate the configuration and the function of the erroneous coin insertion preventive mechanism according to the embodiment 1 of the present invention.

FIGS. 4A, 4B, and 4C are expanded views of the part centering the banknote slot 17 enclosed by the dashed circle j in FIG. 3.

As illustrated in FIG. 4A, an erroneous coin insertion preventive mechanism 20 configured mainly by the banknote slot 17 includes a conveyance path upper surface part 24 which forms a vertical surface 21 and a descending slope surface 22 from the vertical surface 21 in the direction of the inside of the device at the banknote slot 17, and forms a horizontal surface 23 successively to the descending slope surface 22 in the direction of the inside of the device.

The erroneous coin insertion preventive mechanism 20 also includes a conveyance path lower surface part 27 which forms a descending slope surface 25 facing the descending slope surface 22 of the conveyance path upper surface part 24 successively to the horizontal surface of the mounting 16 at the banknote slot 17, and forms a horizontal surface 26 facing the horizontal surface 23 of the conveyance path upper surface part 24 successively to the descending slope surface 25.

As indicated by the arrow k in FIG. 4A, when the coin 28 in FIG. 4B is erroneously inserted through the banknote slot 17, the horizontal surface 26 of the conveyance path lower surface part 27 forms a front end contact part 29 which contacts the front end portion in the insertion direction of the coin 28 as illustrated in FIG. 4B.

Furthermore, the bent part of the conveyance path lower surface part 27, which changes from the horizontal surface of the mounting 16 to the descending slope surface 25, forms a rear lower surface contact part 31 which contacts the lower surface of the rear part in the insertion direction from the center of the coin 28.

The bent part of the conveyance path upper surface part 24, which changes from the descending slope surface 22 to the horizontal surface 23, forms an upper surface intermediate contact part 32 which contacts the upper surface part of the coin 28 at the intermediate position between the front end of the coin 28 which contacts the front end contact part 29 and the rear lower surface part which contacts the rear lower surface contact part 31.

Thus, when the coin 28 is erroneously inserted through the banknote slot 17, the erroneous coin insertion preventive mechanism 20 holds the rigid coin 28 by the three points of the front end contact part 29, the rear lower surface contact part 31, and the upper surface intermediate contact part 32, thereby preventing the coin from entering the inside of the device through the banknote slot 17.

As illustrated in FIG. 4C, a gap L is provided between the descending slope surface 22 of the conveyance path upper surface part 24 and the descending slope surface 25 of the conveyance path lower surface part 27 so that a bundle 33 of a specified number of flexible banknotes may be flexibly bent and pass through the gap.

The gap L is also provided between the horizontal surface 23 of the conveyance path upper surface part 24 and the horizontal surface 26 of the conveyance path lower surface part 27 so that a similar banknote bundle 33 of a specified number of banknotes may pass through the gap. Described below is the positional relationship among the three points of the front end contact part 29, the rear lower surface contact part 31, and the upper surface intermediate contact part 32.

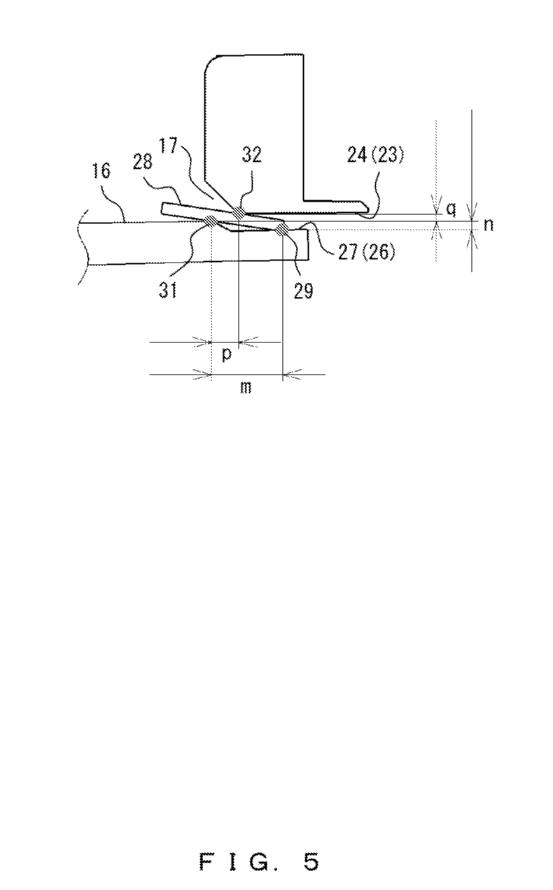

FIG. 5 illustrates the positional relationship among the three points of the front end contact part 29, the rear lower surface contact part 31, and the upper surface intermediate contact part 32. Assume that the vertical gap between the horizontal surface 23 of the conveyance path upper surface part 24 and the horizontal surface 26 of the conveyance path lower surface part 27 is 2.4 mm as with the thickness of the banknote bundle 33 of the specified number of banknotes, the diameter of the coin is 25 mm, and the thickness of the coin is 1.8 mm.

With the above-mentioned settings, and assuming that the horizontal distance between the front end contact part 29 and the rear lower surface contact part 31 is m, the vertical distance between the front end contact part 29 and the rear lower surface contact part 31 is n, the horizontal distance between the rear lower surface contact part 31 and the upper surface intermediate contact part 32 is p, and the vertical distance between the rear lower surface contact part 31 and the upper surface intermediate contact part 32 is q, the positional relationship is set to obtain the values of m=10.4 mm, n=1.3 mm, p=3.9 mm, and q=1.1 mm.

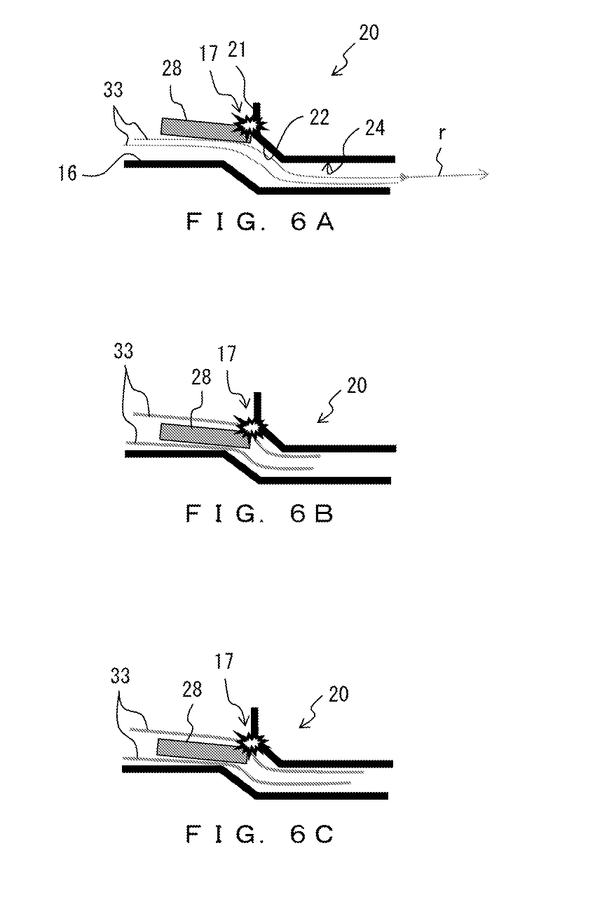

FIGS. 6A, 6B, and 6C illustrate concrete aspects of preventing the coin 28 from entering the banknote slot 17. FIG. 6A illustrates the state in which the banknote handling machine starts feeding banknotes to the inside of the device with the rear end portion of the banknote bundle 33 left outside (on the mounting 16 of) the banknote slot 17.

In this case, as illustrated in FIG. 6A, although the coin 28 is erroneously placed on the banknote bundle 33, the front end of the coin 28 contacts the bent part which forms the descending slope surface 22 from the vertical surface 21 of the conveyance path upper surface part 24, thereby preventing the coin 28 from entering the banknote slot 17, and feeding the banknotes of the banknote bundle 33 sheet by sheet to the inside of the device as indicated by the arrow r with only the coin 28 left outside the banknote slot 17.

FIG. 6B illustrates the case in which the coin 28 is included in the banknote bundle 33 at its forward point. In this case, the rigid coin 28 interrupts the user who is to insert the banknote bundle 33 through the banknote slot 17. Therefore, the user who has recognized the abnormal condition knows that the coin 28 is included in the banknote bundle 33.

FIG. 6C illustrates the case in which the coin 28 is included in the banknote bundle 33 at its backward point. In this case, the user may insert the banknote bundle 33 into the banknote slot 17 to some extent, but the rigid coin 28 interrupts the banknote bundle 33 and prevents the banknote bundle 33 from being inserted farther.

Therefore, the sensor of the inside of the device is not to detect the front end of the banknote bundle 33, and the control unit judges that the banknote bundle 33 has not been inserted into the banknote slot 17, and does not start feeding the banknote bundle 33 to the inside of the device. Accordingly, the user who has recognized the abnormal condition knows that the coin 28 is included in the banknote bundle 33.

In addition, in a banknote handling machine provided with a sensor near the banknote slot 17, the sensor near the inside of the device does not detect the front end of the banknote bundle 33 after the lapse of a specified time although the sensor near the banknote slot 17 detects the banknote bundle 33. Therefore, the abnormal condition may be reported outside from the banknote handling machine.

Thus, the erroneous coin insertion preventive mechanism 20 according to the embodiment of the present invention forms a bent part which vertically bend along the direction of conveyance on the conveyance path surface in the direction of the inside of the device. Therefore, although the coin 28 is placed on the banknote bundle 33 and it is included in the banknote bundle 33, the coin 28 is not taken in the conveyance path farther than the banknote slot 17.

Therefore, the banknote bundle 33 thicker than the coin 28 may be collectively inserted, and the coin 28 may be prevented from being erroneously inserted. In addition, since the coin 28 is not taken inside the device, an occurrence of a fault such as a jam etc. may be prevented.

Simultaneously, since the coin 28 is not taken inside the device, it is not necessary to takes out a coin on the device side, thereby preventing trouble with a user. Furthermore, it is not necessary to stop the device other than the period until the coin 28 is removed.

### Embodiment 2

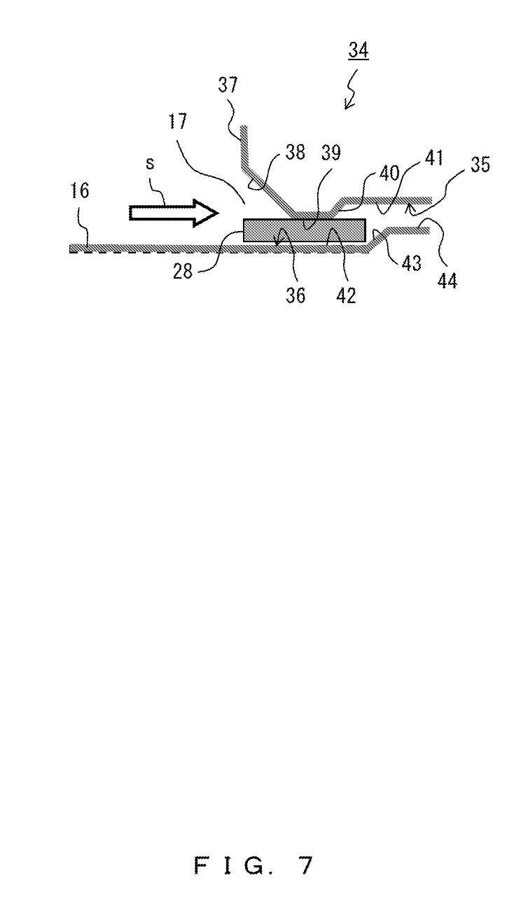

FIG. 7 illustrates the configuration and the function of the erroneous coin insertion preventive mechanism according to the embodiment 2 of the present invention. An erroneous coin insertion preventive mechanism 34 illustrated in FIG. 7 is an erroneous coin insertion preventive mechanism of a banknote handling machine which collectively feeds the banknote bundle 33 (not illustrated in the attached drawings) placed on the mounting 16 and inserted through the banknote slot 17 inside the device from the banknote slot 17.

As illustrated in FIG. 7, the erroneous coin insertion preventive mechanism 34 according to the present embodiment includes a conveyance path upper surface part 35 and a conveyance path lower surface part 36. The conveyance path upper surface part 35 includes a vertical surface 37 and a descending slope surface 38 which descends to the inside of the device from the vertical surface 37 at the banknote slot 17.

Furthermore, the conveyance path upper surface part 35 includes an inlet horizontal surface 39 formed successively to the descending slope surface 38 in the direction of the inside of the device, an ascending slope surface 40 formed successively to the inlet horizontal surface 39 in the direction of the inside of the device, and an inner horizontal surface 41 formed successively to the ascending slope surface 40 in the direction of the inside of the device.

Another conveyance path lower surface part 36 includes an inlet horizontal surface 42 which extends successively to the horizontal surface of the mounting 16 in the direction of the inside of the device from the position of the ascending slope surface 40 of the conveyance path upper surface part 35, an ascending slope surface 43 formed successively to the inlet horizontal surface 42 in the direction of the inside of the device, and an inner horizontal surface 44 formed successively to the ascending slope surface 43 in the direction of the inside of the device.

The gap between the conveyance path upper surface part 35 and the conveyance path lower surface part 36 is formed so that a specified thickness of the banknote bundle 33 illustrated in FIG. 4C may pass through the gap in bent form.

However, when the coin 28 is erroneously inserted through the banknote slot 17 as indicated by the arrow s, the inlet horizontal surface 39 of the conveyance path upper surface part 35 contacts the upper surface intermediate part of the coin 28 whose front end is to be lifted by sliding on the ascending slope surface 43 of the conveyance path lower surface part 36 in the erroneous coin insertion preventive mechanism 34 according to the present embodiment, squeezes the upper surface intermediate part, and suppresses the lift of the coin 28.

Thus, the coin 28 is squeezed by the ascending slope surface 43 of the conveyance path lower surface part 36 and the inlet horizontal surface 39 of the conveyance path upper surface part 35, and is prevented from entering the inside of the device through the banknote slot 17. The effect of the erroneous coin insertion preventive mechanism 34 according to the present embodiment is similar to the case according to the embodiment 1.

### Embodiment 3

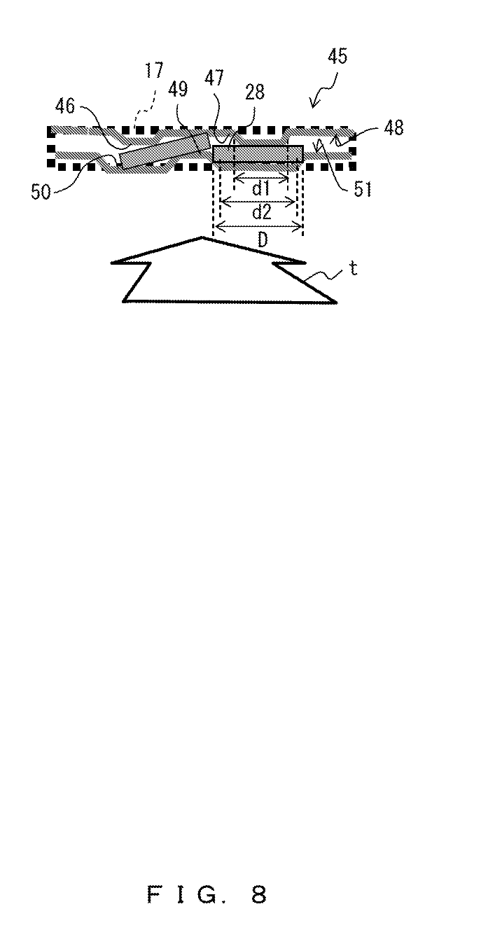

FIG. 8 illustrates the configuration and the function of the erroneous coin insertion preventive mechanism according to the embodiment 3 of the present invention. FIG. 8 is the banknote slot 17 viewed from the front. The mounting 16 illustrated in FIGS. 3 through 5 and FIG. 7 exists in front of the direction of the view in FIG. 8.

An erroneous coin insertion preventive mechanism 45 according to the present embodiment illustrated in FIG. 8 is an erroneous coin insertion preventive mechanism of a banknote handling machine which collectively feeds the banknote bundle 33 (not illustrated in the attached drawings) placed on the mounting 16 (not illustrated in FIG. 8) and inserted through the banknote slot 17 inside the device from the banknote slot 17.

As illustrated in FIG. 8, an erroneous coin insertion preventive mechanism 45 according to the present embodiment includes an upper conveyance path surface part 48 formed by alternately and successively providing a convex part 46 and a concave part 47 in the horizontal slot direction orthogonal to the insertion direction indicated by the arrow t of the banknote bundle 33 at the banknote slot 17.

Furthermore, the erroneous coin insertion preventive mechanism 45 includes a lower conveyance path surface part 51 formed by alternately and successively providing a convex part 49 and a concave part 50 in the horizontal slot direction orthogonal to the insertion direction of the banknote bundle 33 at the banknote slot 17.

The convex part 49 and the concave part 50 of the lower conveyance path surface part 51 are formed to face respectively the concave part 47 and the convex part 46 of the upper conveyance path surface part 48, the convex part 49 has the same shape as the convex part 46 but is opposite in direction. The convex part 49, and the concave part 50 has the same shape as the concave part 47 but is opposite in direction.

Furthermore, the convex part 46 and the concave part 47 of the upper conveyance path surface part 48, and the convex part 49 and the concave part 50 of the lower conveyance path surface part 51 are formed to have a width d1 and a width d2 respectively smaller than the diameter D of the coin 28 erroneously inserted to the banknote slot 17.

Thus, when the rigid coin 28 is erroneously inserted through the banknote slot 17, it is interrupted by the convex part 46 and the concave part 47 of the upper conveyance path surface part 48 and the convex part 49 and the concave part 50 of the lower conveyance path surface part 51, and is prevented from entering the inside of the device from the banknote slot 17.

The vertical distance between the convex part 49 and the concave part 50 of the lower conveyance path surface part 51 and the facing concave part 47 and convex part 46 of the upper conveyance path surface part 48 is made not less than the specified thickness of the banknote bundle 33 to be inserted through the banknote slot 17.

Thus, when inserted through the banknote slot 17, the banknote bundle 33 may enter the inside of the device while being bent horizontally. The effect of the erroneous coin insertion preventive mechanism 45 according to the present embodiment is similar to the case according to the embodiment 1.

The present invention is not limited to the applications above. For example, it is not necessary that the convex part 46 and the convex part 49, and the concave part 50 and the concave part 47 are of the same shape, but have the shape in which a coin, a token, etc. are prevented from entering inside. Otherwise, a coin is not limited to a coin, but may be an object of a similar shape such as a token etc.

Furthermore, the above-mentioned embodiments may be variously modified within the scope of the gist of the embodiments. In addition, the above-mentioned embodiments may be variously modified or changed by those skilled in the art, and are not limited to the correct configurations and applications described above.

The present invention may be applied to an erroneous coin insertion preventive mechanism a banknote handling machine which allows a user to prevent from erroneously inserting a coin (or a token) through a banknote slot of the banknote handling machine.

What is claimed is:

1. An erroneous coin insertion preventive mechanism of a banknote handling machine which collectively feeds a bundle of banknotes, which are placed on amounting and inserted through a banknote slot, from the banknote slot to the inside of a device, comprising:
a conveyance path upper surface which forms a vertical surface and a descending slope surface from the vertical surface in a direction of the inside of the device at the banknote slot, and forms a horizontal surface in the direction of the inside of the device successively to the descending slope surface; and
a conveyance path lower surface which forms a descending slope surface facing the descending slope surface of the descending slope surface of the conveyance path upper surface successively to the horizontal surface of the mounting at the banknote slot, and a horizontal surface facing the horizontal surface of the conveyance path upper surface successively to the descending slope surface, wherein
the horizontal surface of the conveyance path lower surface forms a front end contact part which contacts an insertion direction front end part of a coin when the coin is erroneously inserted through the banknote slot,
a bent part which changes from the horizontal surface of the mounting of the conveyance path lower surface to the descending slope surface forms a rear lower surface contact part which contacts a lower surface of a rear part in the insertion direction from a center of the coin when the coin is erroneously inserted through the banknote slot,
a bent part which changes from the descending slope surface of the conveyance path upper surface to the horizontal surface forms an upper surface intermediate contact part which contacts an upper surface part of the coin at an intermediate position between a front end which contacts the front end contact surface of the coin when the coin is erroneously inserted through the banknote slot and a rear lower surface part which contacts the rear lower surface contact part, and
three points of the front end contact part, the rear lower surface contact part, and the upper surface intermediate contact part support the coin when the coin is erroneously inserted through the banknote slot, and the three points prevent the coin from entering the inside of the device through the banknote slot.

2. The mechanism according to claim 1, wherein
a horizontal distance between the front end contact part and the rear lower surface contact part is 10.4 mm,
a vertical distance between the front end contact part and the rear lower surface contact part is 1.3 mm,
a horizontal distance between the rear lower surface contact part and the upper surface intermediate contact part is 3.9 mm, and
a vertical distance between the rear lower surface contact part and the upper surface intermediate contact part is 1.1 mm
when a gap between the horizontal surface of the conveyance path upper surface and the horizontal surface of the conveyance path lower surface is 2.4 mm, a diameter of the coin is 25 mm, and a thickness of the coin is 1.8 mm.

3. An erroneous coin insertion preventive mechanism of a banknote handling machine which collectively feeds a bundle of banknotes, which are placed on a mounting and inserted through a banknote slot, from the banknote slot to the inside of a device, comprising:
a conveyance path upper surface which forms a vertical surface and a descending slope surface from the vertical surface in a direction of the inside of the device at the banknote slot, forms an inlet horizontal surface successively to the descending slope surface in the direction of the inside of the device, forms an ascending slope surface successively to the inlet horizontal surface in the direction of the inside of the device, and forms an internal horizontal surface successively to the ascending slope surface in the direction of the inside of the device; and
a conveyance path lower surface which forms an inlet horizontal surface extending in the direction of the inside of the device from the position of the ascending slope surface of the conveyance path upper surface and an ascending slope surface successively to the inlet horizontal surface in the direction of the inside of the device, and forms an internal horizontal surface successively to the ascending slope surface in the direction of the inside of the device, wherein
when the coin is erroneously inserted through the banknote slot, the inlet horizontal surface of the conveyance path upper surface contacts an upper surface intermediate part of the coin whose front end is being lifted in contact with the ascending slope surface of the conveyance path lower surface, and squeezes the upper surface intermediate part of the coin, and
the ascending slope surface of the conveyance path lower surface and the inlet horizontal surface of the conveyance path upper surface squeeze the coin, thereby preventing the coin from entering the inside of the device through the banknote slot.

4. An erroneous coin insertion preventive mechanism of a banknote handling machine which collectively feeds a bundle of banknotes, which are placed on a mounting and inserted through a banknote slot, from the banknote slot to the inside of a device, comprising:
an upper conveyance path surface formed by alternately and successively providing a convex part and a concave part in the horizontal slot direction orthogonal to a banknote bundle insertion direction at the banknote slot; and
a lower conveyance path surface formed by alternately and successively providing a convex part and a concave part in the horizontal slot direction orthogonal to a banknote bundle insertion direction at the banknote slot, wherein
the convex part and the concave part of the lower conveyance path surface respectively face the concave part and the convex part of the upper conveyance path surface,
the convex part and the concave part of the upper conveyance path surface and the convex part and the concave part of the lower conveyance path surface are formed as having a width smaller than a diameter of the coin which is erroneously inserted through the banknote slot, and
a vertical distance between the convex part and the concave part of the lower conveyance path surface and the facing concave part and the convex part of the upper conveyance path surface is the distance which allows the bundle of banknotes to be inserted to pass through the banknote slot.
